(19) United States
(12) Patent Application Publication
(10) Pub. No.: US 2008/0130274 A1
(43) Pub. Date: Jun. 5, 2008

(54) PORTABLE LIGHTING DEVICE AND METHOD THEREOF

(76) Inventors: Gary Fails, Tappan, NY (US); Lauren Dunn, New York, NY (US); Benjamin Merrick, Batler, NJ (US); Adam Klein, Bronx, NY (US)

Correspondence Address: MALDJIAN & FALLON LLC, 365 BROAD ST. , 3RD FLOOR, RED BANK, NJ, 07701, US

(21) Appl. No.: 11/940,405

(22) Filed: Nov. 15, 2007

Related U.S. Application Data
(60) Provisional application No. 60/866,011, filed on Nov. 15, 2006.

(51) Int. Cl. F21L 4/00

(52) U.S. Cl. 362/157

(57) ABSTRACT

Embodiments of the present invention generally relate to a portable lighting device and method thereof. More specifically, embodiments of the present invention relate to a portable lighting device having a housing comprising a power supply, controller, and light-emitting diode (LED) panel. In one embodiment of the present invention, a portable lighting device comprises a housing having a base and a lid, a power supply and a controller disposed within the base, and at least one light-emitting diode (LED) panel disposed on an inner surface of the lid.

### CROSS-REFERENCE TO RELATED APPLICATIONS

This application claims the benefit of U.S. Provisional Patent Application Ser. No. 60/866,011, filed on Nov. 15, 2006, entitled “Portable Lighting Device and Method Thereof,” the disclosure of which is incorporated herein by reference in its entirety.

### BACKGROUND OF THE INVENTION

1. Field of the Invention

Embodiments of the present invention generally relate to a portable lighting device and method thereof. More specifically, embodiments of the present invention relate to a portable lighting device having a housing comprising a power supply, controller, and light-emitting diode (LED) panel.

2. Description of the Related Art

Proper lighting is of great importance with respect to the entertainment industry. Traditionally, entertainment productions (i.e., theater, movies, etc.) were presented or recorded in a substantially permanent structure or venue, and thus the weight, size, and portability of the lighting devices were not of concern. However, entertainment lighting is more frequently being utilized in outdoor venues, temporary structures, and the like. As such, there is an increasing need for portable lighting systems which are also versatile and can be easily mounted in convenient and desirable positions.

Currently, portable lighting systems in the market are not capable of providing the same lighting attributes that conventional theater lighting systems provide. For example, current portable lighting systems fail to provide selectable controllability for each of the lighting parameters of the various lighting fixtures in a lighting system.

Thus, a need exists for a portable lighting device, system and methods thereof with desirable lighting characteristics.

### SUMMARY OF THE INVENTION

Embodiments of the present invention generally relate to a portable lighting device and method thereof. In one embodiment of the present invention, a portable lighting device comprises a housing having a base and a lid, a power supply and a controller disposed within the base, and at least one light-emitting diode panel disposed on an inner surface of the lid.

In another embodiment of the present invention, a portable lighting system comprises a plurality of portable lighting devices, each device having a housing comprising a base and a lid, a power supply, a controller, and a wireless transceiver disposed within the base, and at least one light-emitting diode panel disposed on an inner surface of the lid, whereby at least one of the plurality of portable lighting devices is designated as a host device for individually controlling the remainder of the portable lighting devices.

In yet another embodiment of the present invention, a stackable lighting device comprises a housing having a base and a lid, a rechargeable battery and a controller disposed within the base, at least one light-emitting diode panel disposed on an inner surface of the lid, a protruding handle on a first sidewall of the base, and a recess in a second sidewall of the base, opposite the first sidewall, complimentary to the protruding handle.

While the following is directed to embodiments of the present invention, other and further embodiments of the invention may be devised without departing from the basic scope thereof.

### BRIEF DESCRIPTION OF THE DRAWINGS

So the manner in which the above recited features of the present invention can be understood in detail, a more particular description of the invention, briefly summarized above, may be had by reference to embodiments, some of which are illustrated in the appended drawings. It is to be noted, however, the appended drawings illustrate only typical embodiments of this invention and are therefore not to be considered limiting of its scope, for the invention may admit to other equally effective embodiments.

FIG. 1 is a perspective view of a portable lighting device in accordance with an embodiment of the present invention;

FIG. 2 is perspective back view of the portable lighting device of FIG. 1; and

FIG. 3 is a perspective view of a stack of portable lighting devices in accordance with an embodiment of the present invention.

While the invention is described herein by way of example using several embodiments and illustrative drawings, those skilled in the art will recognize the invention is not limited to the embodiments of drawing or drawings described. It should be understood the drawings and detailed description thereto are not intended to limit the invention to the particular form disclosed, but to the contrary, the invention is to cover all modification, equivalents and alternatives. The headings used herein are for organizational purposes only and are not meant to be used to limit the scope of the description. As used throughout this application, the word “may” is used in a permissive sense (i.e., meaning having the potential to), rather than the mandatory sense (i.e., meaning must). Similarly, the words “include,” “including,” and “includes” mean including, but not limited to.

### DETAILED DESCRIPTION

Embodiments of the present invention generally relate to a portable lighting device and method thereof. In one embodiment of the present invention, a portable lighting device comprises a housing having a base and a lid, a power supply and a controller disposed within the base, and at least one light-emitting diode panel disposed on an inner surface of the lid.

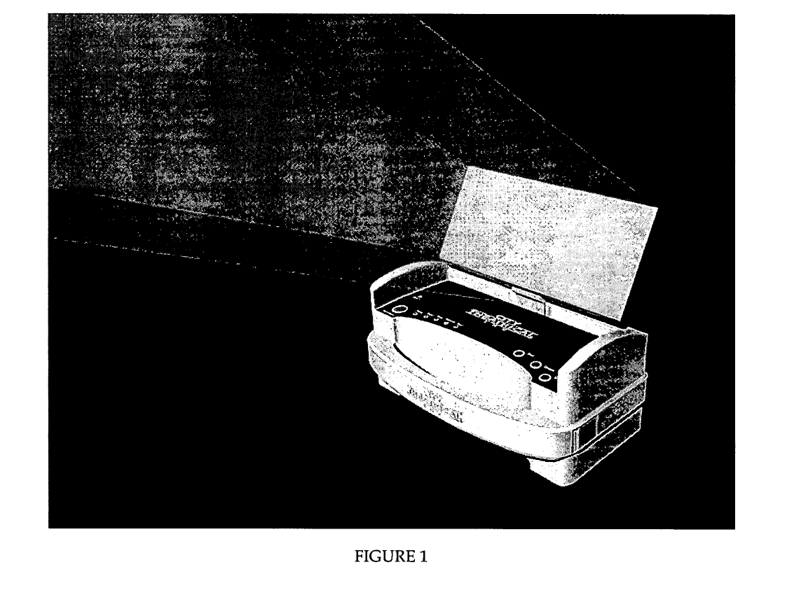

FIG. 1 is a perspective view of a portable lighting device in accordance with an embodiment of the present invention. A portable lighting device 100 generally comprises a housing 102, a controller (not shown), a light-emitting diode (LED) display 104, and a power source (not shown). The housing 102 typically comprises a base 106 and a lid 108. In one embodiment, the lid 108 is rotatably attached to the base 106 via a hinge 110. In one embodiment, a lid is capable of at least 180 degrees rotation from a closed position (i.e., a position of 0 degrees). In another embodiment, the lid may be open to approximately 270 degrees from a closed position.

Other embodiments of the present invention provide the lid 108 may be readily separable from the base 106. In such embodiments, the lid 108 is generally provided with a fastening device to secure it to the base 106 when desired. Such fastening devices include: snap fittings, clips, hooks, other known means for sealing a lid, and the like.

The lid 108 generally comprises at least an LED panel 112 on an inner surface 114 of the lid 108. The LED panel 112 may be any LED apparatus useful for embodiments of the present invention. In one embodiment, the LED panel 112 is one of the LED apparatuses disclosed by U.S. Pat. Nos. 6,016,038 and 6,150,774, commercially available by Color Kinetics, Inc., of Boston, Mass., under the registered trademark ColorBlast®, which are incorporated herein by reference in their entirety. In other embodiments, the LED panel may incorporate other commercially available LED devices. Other light emitting sources, recognized as functional equivalents of LEDs by those of ordinary skill in the art, may also be utilized in embodiments of the present invention.

A top surface 116 of the base 106 is generally provided with a control panel 118 for providing instructions through the controller to the LED panel 112. The control panel 118 provides a user interface for manual control of the operation of the LED panel 112. In one embodiment, the control panel 118 receives instructions relating to the brightness, color, speed, or the like, of the LED panel 112. In another embodiment, the control panel 118 provides an on/off toggle switch for the LED panel 112, providing overall power control as well as strobe and flashing effects. In yet another embodiment, the control panel 118 provides controls for establishing host/client relationships between a plurality of portable lighting devices, the operation of which is described below. Optionally, the control panel 118 may be accompanied by a remote control device, for wirelessly controlling the operation of the LED panel 112.

The control panel 118 may optionally comprise a monitor (not shown) for displaying the status of the controllable parameters of the portable lighting device 100 at any given time. When utilized in conjunction with a plurality of portable lighting devices, as described in detail below, the monitor may also display the status of the respective devices' controllable parameters as well.

The controller generally comprises any controller known in the lighting and/or entertainment industry capable of operating an LED panel 112. In one embodiment, the controller utilizes the DMX512 communication protocol developed by the U.S. Institute for Theater Technology, Inc. (USITT) Engineering Commission and adopted by the Entertainment Services and Technology Association (ESTA). In another embodiment, the controller may use the Remote Device Management (RDM) protocol or the Advanced Control Network (CAN) protocol, both developed by ESTA.

As is understood in the industry, the DMX512 protocol is a serial communication protocol that allows addressing control, or data, channels per a data link and assigning, in a range from OFF to ON, up to 256 settings for each data channel. Generally, the data is transmitted from the controller, at up to 250 Kb/s, over two shielded wires using, for example, the RS-485 transmission standard. Each data channel typically corresponds to at least one controllable parameter of one of the LED panels.

Optionally, in several embodiments, the controller comprises a wireless transceiver. The transceiver may facilitate a bi-directional wireless interface between a controller and an LED panel. The transceiver generally comprises a protocol converter, a transceiver module having a transmitting/receiving antenna, and a control module. Generally, the transceiver is provided in the form of electronic hardware, e.g., printed circuit board (PCB), plug-in module, etc., or software. In one exemplary embodiment, the controller comprises a transceiver as described in United States Patent Application Publication No. 2005/0286646, published Dec. 29, 2005, by Fails et al, commercially available from City Theatrical, Inc., of Carlstadt, N.J., under the WDS or PDS series. The disclosure of the above-mentioned publication, and the publicly available information regarding the commercially available embodiments, are incorporated herein by reference in their entireties.

The transceiver generally operates at one of a plurality of radio channels (e.g., 32 or more channels) at about 2.4 GHz or greater, using a Frequency Hopping Spread Spectrum (FHSS) or Spread Spectrum Frequency Channel Hopping Radio (SSFCHR) technology. Other known wireless technologies, such as IEEE 802.11 Ethernet Direct Sequence Spread Spectrum (DSSS), may be utilized in embodiments of the present invention.

The power supply of the portable lighting device 100 may be any power supply suitable for embodiments of the present invention. In one embodiment, standard AC or DC power is provided to the portable lighting device. In another embodiment, the power source comprises a battery. The battery may be any known primary or rechargeable battery type, including, but not limited to at least one of a Zinc-carbon battery, Zinc-chloride battery, Alkaline battery, Silver-oxide battery, Lithium Iron Disulphide battery, Lithium-Thionyl Chloride battery, Mercury battery, Zinc-air battery, Thermal battery, Water-activated battery, Nickel Oxyhydroxide battery, Nickel-cadmium battery, Nickel-metal hydride battery (NiMH), and a Rechargeable alkaline battery. In certain embodiments, a battery may provide sufficient power for an LED panel run time of at least about 8 hours to about 12 hours.

In many embodiments, a battery power supply is rechargeable via a standard AC or DC power source. In several embodiments, the AC or DC power is provided to the battery utilizing a power cord (not shown). Alternatively, the AC or DC may be provided to the power supply via an electrically conductive means (not shown) positioned on an external surface of the portable lighting device 100. Such electrically conductive means may include a conductive metallic panel (e.g., a copper strip, etc.), an outlet, solar panel, energy port, or the like. It is understood that any known energy source may be utilized as an electrically conductive means to recharge the power supply of embodiments of the present invention.

The housing 102 may optionally comprise a protruding handle 120. In one embodiment, the handle 120 protrudes from a front sidewall of the base 106 of housing 102. The handle 120 may be integrally formed with the housing 102, and is designed to support the weight and handling of the portable lighting device 100.

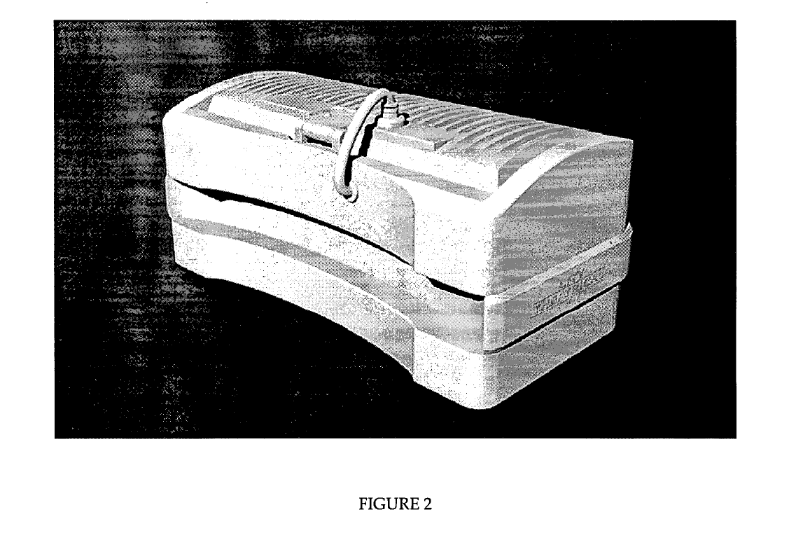

FIG. 2 is perspective view of the back of portable lighting device of FIG. 1. In one embodiment, the portable lighting device 100 is provided with a recessed portion 122. The recessed portion is typically positioned in a back sidewall of the base 106 of the housing 102, and is designed to be complimentary to the handle 120, as described above.

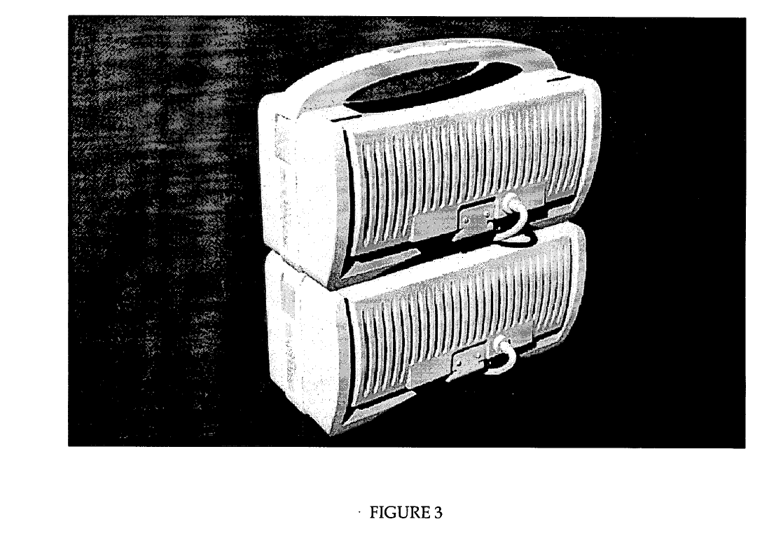

FIG. 3 is a perspective view of a stack of portable lighting devices in accordance with an embodiment of the present invention. In one embodiment, a portable lighting device 100 is capable of stacking on another portable lighting device. In such an embodiment, the portable lighting devices are each provided with a handle 120 and a recessed portion 122. When stacked, the portable lighting devices are incapable of tangential motion relative to one another. This is an advantageous feature of certain embodiments of the present invention whereas it facilitates ease of transport and storage. Optionally, each of the portable lighting devices 100 may be provided with a locking mechanism to secure an adjacently stacked portable lighting device. In one embodiment, at least six portable lighting devices may safely be stacked on top of one another.

In several embodiments, it may be desirable to recharge a stack of portable lighting devices simultaneously. In such an embodiment, each of the portable lighting devices 100 typically comprises an electrically conductive means on a bottom surface of the housing 102. In one embodiment, the electrically conductive means is positioned within a recessed portion 122 of the base 106. Similarly, each of the portable lighting devices 100 may further comprise an electrically conductive means on the handle 120 of the housing 102. The electrically conductive means on the handle 120 is positioned such that when two portable lighting devices 100 are stacked, the electrically conductive means on the handle 120 a first device aligns with the electrically conductive means in a recessed portion 122 of a second device. In such a manner, by providing an energy source to the first device, the second device may also be recharged.

Optionally, embodiments of the present invention provide a truck bed, dolley, cart, or other known transportation medium may comprise a recharging station with an energy source for recharging the battery power source of the portable lighting devices. In one embodiment, a stack of portable lighting devices may be recharged when a bottom device in the stack of devices is positioned on the recharging station.

A plurality of portable lighting devices in accordance with of embodiments of the present invention may be utilized in conjunction with one another to form a portable lighting system. In one embodiment, at least two portable lighting devices comprising wireless transceivers are provided in a portable lighting system. One of the portable lighting devices may be designated a host device via the control panel on the respective device. Subsequently, the remaining device is designated the client device via the control panel. Once established, the host device is capable of controlling the client device via wirelessly transmitted instructions. Utilizing such an embodiment provides a user the ability to sync, compliment, or otherwise pair two or more lighting devices via a single control panel.

Embodiments of the portable lighting system are entirely scalable to as many portable lighting devices as needed in a single system. In certain embodiments, where a multitude of portable lighting devices are utilized in a single system, it may be desirable to designate a single device as a host device, and a plurality of other devices as sub-hosts. For example, in one embodiment, a portable lighting system may be spread over a significant area, such that a low-frequency signal transmitted from a host device may not reach a remotely positioned client device. As such, an intermediary device (i.e., a third portable lighting device) may be designated as a sub-host to re-transmit the original signal from the host device, such that the distance each signal must travel is significantly less. By utilizing sub-hosts, it is conceivable that a portable lighting system in accordance with embodiments of the present invention could extend across a limitless area.

In accordance with additional embodiments of the present invention, each client may be separately controllable from a single host. Alternatively, each client may be designated within a subset of clients to be controlled as a group. It is conceivable that any arrangement of hosts, sub-hosts, and clients are within the scope of the embodiments of the present invention.

In accordance with embodiments of the present invention, the portable lighting device 100 may be waterproof. In such an embodiment, the housing 102 may be sealed so minimal or negligible liquid may penetrate through any surface or seam to infiltrate an interior portion of the housing 102. This may be desirable for outdoor applications where rain, snow, or other water sources may be near a portable lighting device 100. Furthermore, a waterproof casing allows embodiments of the present invention the device to be used in emergency situations, for example, by emergency or rescue services where liquid, in any form, may be present.

In other embodiments of the present invention, a portable lighting device is provided with sufficient LED power to meet military lighting, government emergency lighting (e.g., FEMA), and other highly-regulated lighting standards. The ability to regulate the LED power is also advantageous for portable lighting devices in accordance with embodiments of the present invention in professional lighting, semi-professional lighting, or amateur lighting environments. As such, embodiments of the portable lighting device provided herein are designed to be utilized in at least the following environments: entertainment industry applications (i.e., tent events, weddings, trade shows, outdoor functions, and the like), lighting rental companies, tent rental companies, emergency and rescue services, and military applications.

While the foregoing is directed to embodiments of the present invention, other and further embodiments of the invention may be devised without departing from the basic scope thereof.

What is claimed is:

1. A portable lighting device comprising:
a housing having a base and a lid;
a power supply and a controller disposed within the base; and
at least one light-emitting diode panel disposed on an inner surface of the lid.

2. The portable lighting device of claim 1 further comprising a wireless transceiver device.

3. The portable lighting device of claim 1, wherein the controller utilizes a DMX512 communication protocol.

4. The portable lighting device of claim 1 further comprising a control panel for instructing the controller.

5. The portable lighting device of claim 4, wherein the control panel is located on a top surface of the base.

6. The portable lighting device of claim 1 wherein the lid is rotatably connected to the base via at least a hinge along an edge of the lid.

7. The portable lighting device of claim 1, further comprising a protruding handle on a first sidewall of the base.

8. The portable lighting device of claim 7, further comprising a recess in a second sidewall of the base, opposite the first sidewall, complimentary to the protruding handle.

9. The portable lighting device of claim 1, wherein the power supply comprises a rechargeable battery.

10. The portable lighting device of claim 1, wherein the housing is substantially waterproof.

11. A portable lighting system comprising:
a plurality of portable lighting devices, each device having:
a housing comprising a base and a lid;
a power supply, a controller, and a wireless transceiver disposed within the base; and
at least one light-emitting diode panel disposed on an inner surface of the lid;
whereby at least one of the plurality of portable lighting devices is designated as a host device for individually controlling the remainder of the portable lighting devices.

12. The portable lighting system of claim 11, wherein the plurality of portable lighting devices communicate among each other utilizing a DMX512 communication protocol.

13. The portable lighting system of claim 11, whereby the at least one host device further comprises a control panel for inputting instructions for each individual controller of the remainder of portable lighting devices.

14. The portable lighting system of claim 13, wherein the instructions inputted on the control panel of the at least one host device are wirelessly communicated to the remainder of portable lighting devices.

15. The portable lighting system of claim 11, wherein the lid of each of the portable lighting devices is rotatably connected to the base of the device via at least a hinge along an edge of the lid.

16. The portable lighting system of claim 11, wherein each of the portable lighting devices further comprise a protruding handle on a first sidewall of the base.

17. The portable lighting system of claim 16, wherein each of the portable lighting devices further comprise a recess in a second sidewall of the base, opposite the first sidewall, complimentary to the protruding handle.

18. The portable lighting system of claim 11, wherein the power supply comprises a rechargeable battery.

19. A stackable lighting device comprising:
a housing having a base and a lid;
a rechargeable battery and a controller disposed within the base;
at least one light-emitting diode panel disposed on an inner surface of the lid;
a protruding handle on a first sidewall of the base; and
a recess in a second sidewall of the base, opposite the first sidewall, complimentary to the protruding handle.

20. The stackable lighting device of claim 19 further comprising an electrically conductive means positioned along the second sidewall of the base for receiving an electric current to recharge the battery.
